(19) United States
(12) Patent Application Publication
(10) Pub. No.: US 2008/0177867 A1
(43) Pub. Date: Jul. 24, 2008

(54) CONFIGURATION OF A MEMORY CONTROLLER IN A PARALLEL COMPUTER SYSTEM

(76) Inventors: Mark Edwin Giampapa, Irvington, NY (US); Thomas Michael Gooding, Rochester, MN (US); Brian Paul Wallenfelt, Eden Prairie, MN (US)

Correspondence Address: MARTIN & ASSOCIATES, LLC, P.O. BOX 548, CARTHAGE, MO, 64836-0548, US

(21) Appl. No.: 11/624,866

(22) Filed: Jan. 19, 2007

(51) Int. Cl. G06F 15/177

(52) U.S. Cl. 709/220

(57) ABSTRACT

A method and apparatus for configuration of a memory controller in a parallel computer system using an extensible markup language (XML) configuration file. In preferred embodiments an XML file with the operation parameters for the memory controller is stored in a bulk storage and used by the computers service node to create a personality file with binary register data that is transferred to static memory. The binary register data is then used during the boot process of the compute nodes to configure the memory controller.

### BACKGROUND OF THE INVENTION

1. Technical Field

This invention generally relates to configuration of a memory controller in a computing system, and more specifically relates to configuration of a memory controller in a massively parallel super computer.

2. Background Art

Computer systems store information on many different types of memory and mass storage systems that have various tradeoffs between cost and speed. One common type of data storage on modern computer systems is dynamic random access memory (DRAM). Banks of DRAM require a memory controller between the memory and a computer processor that accesses the memory. The controller must be configured with specific parameters to control the access to the DRAM. One common type of DRAM is double data rate synchronous DRAM (DDR SDRAM). The memory controller for the DDR SDRAM is referred to as a DDR controller.

Massively parallel computer systems are one type of computer system that use DDR SDRAM memory and a DDR memory controller. A family of massively parallel computers is being developed by International Business Machines Corporation (IBM) under the name Blue Gene. The Blue Gene/L system is a scalable system in which the current maximum number of compute nodes is 65,536. The Blue Gene/P system is a similar scalable system under development. The Blue Gene/L node consists of a single ASIC (application specific integrated circuit) with 2 CPUs and memory. The full computer would be housed in 64 racks or cabinets with 32 node boards in each rack.

On a massively parallel super computer system like Blue Gene, the DDR controller must be properly configured to communicate with and control the SDRAM chips in the DDR memory. The configuration parameters for the DDR controller are often different depending on the type and manufacturer of the SDRAM. In the prior art, the DDR controller was configured with low level code loaded with a boot loader into the nodes of the massively parallel super computer. This required a different boot loader to be prepared and compiled depending on the type and manufacturer of the memory in the node boards, or for other memory controller parameters. Thus, for each system provided to a customer, or for a new replacement of node cards, a new boot loader needed to be prepared and compiled with the correct DDR controller parameters.

Without a way to more effectively configure the DDR controllers, super computers will require manual effort to reconfigure systems with different memory on the compute nodes thereby wasting potential computer processing time and increasing maintenance costs.

### DISCLOSURE OF INVENTION

According to the preferred embodiments, a method and apparatus is described for configuration of a memory controller in a parallel computer system using an extensible markup language (XML) configuration file. In preferred embodiments an XML file with the operation parameters for a memory controller is stored in a bulk storage and used by the computers service node to create a personality. The personality has binary register data that is transferred to static memory in the compute nodes by the service node of the system. The binary register data is then used during the boot process of the compute nodes to configure the memory controller.

The disclosed embodiments are directed to the Blue Gene architecture but can be implemented on any parallel computer system with multiple processors. The preferred embodiments are particularly advantageous for massively parallel computer systems.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of a massively parallel computer system according to preferred embodiments;

FIG. 2 is a block diagram of a compute node memory structure in a massively parallel computer system according to the prior art;

FIG. 3 illustrates an example of configuring a DDR controller with an XML file according to preferred embodiments;

FIG. 4 illustrates an example XML file according to preferred embodiments;

FIG. 5 illustrates an example of register data from the XML file shown in FIG. 4 according to preferred embodiments;

FIG. 6 is a method flow diagram for configuring a memory controller in a massively parallel computer system according to a preferred embodiment; and

FIG. 7 is another method flow diagram for configuring a memory controller in a massively parallel computer system according to a preferred embodiment.

### BEST MODE FOR CARRYING OUT THE INVENTION

The present invention relates to an apparatus and method for configuration of a DDR controller in a massively parallel super computer system using an XML configuration file. In preferred embodiments an XML file with the DDR settings is stored in a bulk storage and used by the computers service node to create DDR controller parameters in a personality file that is transferred to the compute nodes during the boot process. The preferred embodiments will be described with respect to the Blue Gene/L massively parallel computer being developed by International Business Machines Corporation (IBM).

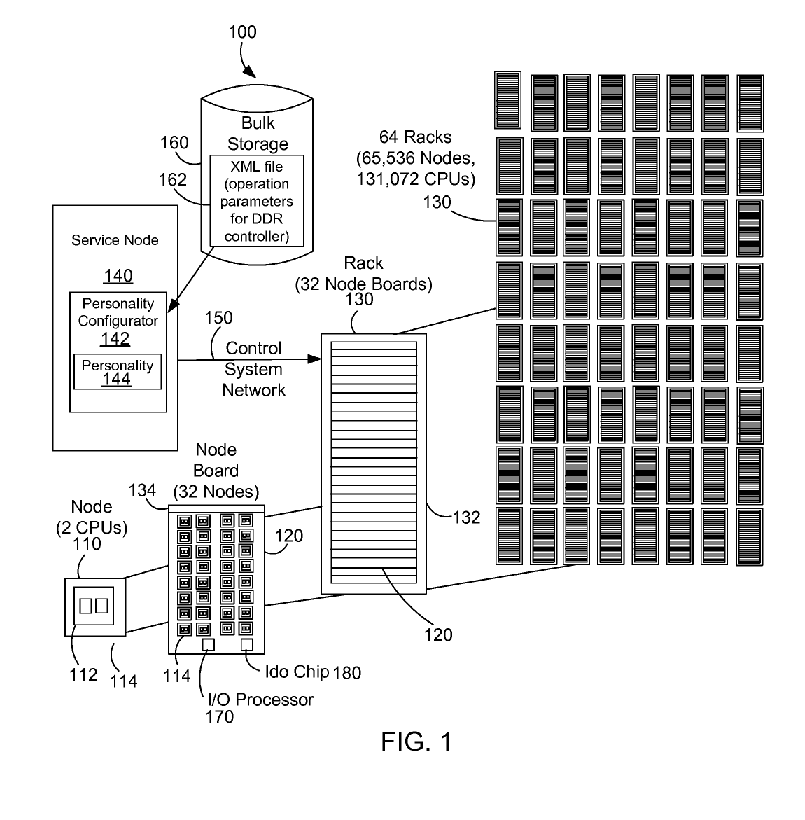

FIG. 1 shows a block diagram that represents a massively parallel computer system 100 such as the Blue Gene/L computer system. The Blue Gene/L system is a scalable system in which the maximum number of compute nodes is 65,536. Each node 110 has an application specific integrated circuit (ASIC) 112, also called a Blue Gene/L compute chip 112. The compute chip incorporates two processors or central processor units (CPUs) and is mounted on a node daughter card 114. The node also typically has 512 megabytes of local memory. A node board 120 accommodates 32 node daughter cards 114 each having a node 110. Thus, each node board has 32 nodes, with 2 processors for each node, and the associated memory for each processor. A rack 130 is a housing that contains 32 node boards 120. Each of the node boards 120 connect into a midplane printed circuit board 132 with a midplane connector 134. The midplane 132 is inside the rack and not shown in FIG. 1. The full Blue Gene/L computer system would be housed in 64 racks 130 or cabinets with 32 node boards 120 in each. The full system would then have 65,536 nodes and 131,072 CPUs (64 racks×32 node boards×32 nodes×2 CPUs).

The Blue Gene/L computer system structure can be described as a compute node core with an I/O node surface, where communication to 1024 compute nodes 110 is handled by each I/O node that has an I/O processor 170 connected to the service node 140. The I/O nodes have no local storage. The I/O nodes are connected to the compute nodes through the collective network and also have functional wide area network capabilities through a gigabit ethernet network. The connections to the compute nodes is similar to the connections to the compute node except the I/O nodes are not connected to the torus network.

Again referring to FIG. 1, the computer system 100 includes a service node 140 that handles the loading of the nodes with software and controls the operation of the whole system. The service node 140 is typically a mini computer system such as an IBM pSeries server running Linux with a control console (not shown). The service node 140 is connected to the racks 130 of compute nodes 110 with a control system network 150. The control system network provides control, test, and bring-up infrastructure for the Blue Gene/L system. The control system network 150 includes various network interfaces that provide the necessary communication for the massively parallel computer system. The Ethernet network is connected to an I/O processor 170 located on a node board 120 that handles communication from the service node 160 to a number of nodes. In the Blue Gene/P system, an I/O processor 170 is installed on a node board 120 to communicate with 1024 nodes in a rack.

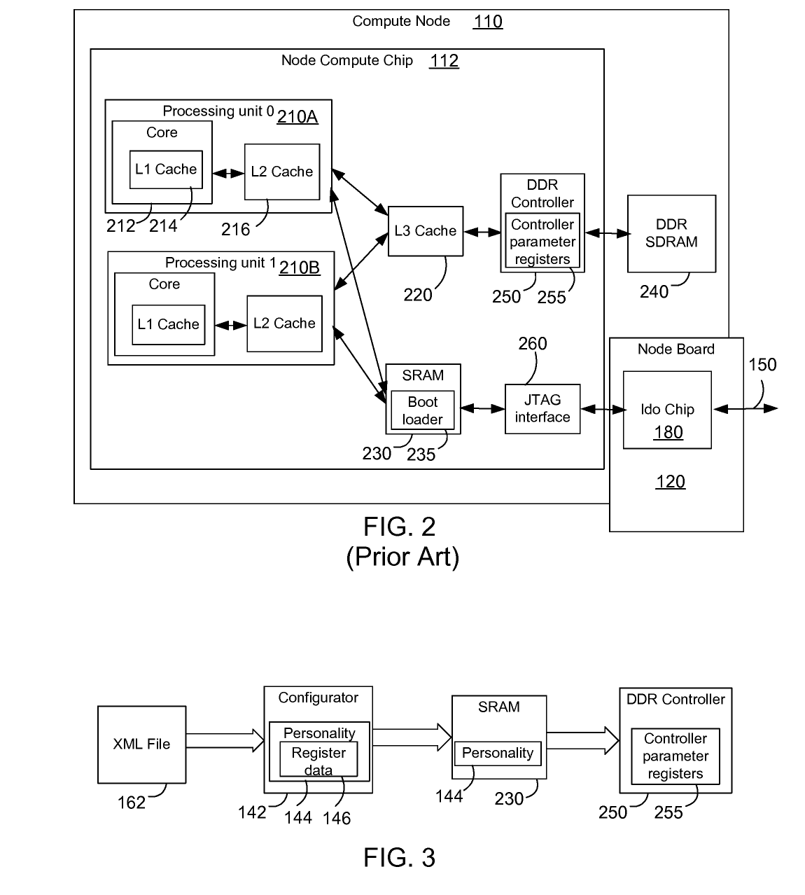

The service node manages another private 100-Mb/s Ethernet network dedicated to system management through an Ido chip 180. The service node is thus able to control the system, including the individual I/O processors and compute nodes. This network is sometime referred to as the JTAG network since it communicates using the JTAG protocol. Thus, from the viewpoint of each I/O processor or compute node, all control, test, and bring-up is governed through its JTAG port communicating with the service node. This network is described further below with reference to FIG. 2.

Again referring to FIG. 1, the Blue Gene/L supercomputer includes bulk storage 160 that represents one or more data storage devices such as hard disk drives. In preferred embodiments, the bulk storage holds an extensible markup language (XML) file 162 that was created previously. The XML file 162 is created that contains operation parameters for the DDR controller for each node in the computer system. The personality configurator 142 is a software program executing on the service node 140 that uses the XML file 162 to create a personality to be used to configure the DDR memory controller each node as described further below.

The Blue Gene/L supercomputer communicates over several additional communication networks. The 65,536 computational nodes are arranged into both a logical tree network and a logical 3-dimensional torus network. The logical tree network connects the computational nodes in a binary tree structure so that each node communicates with a parent and two children. The torus network logically connects the compute nodes in a three-dimensional lattice like structure that allows each compute node to communicate with its closest 6 neighbors in a section of the computer. Other communication networks connected to the node include a Barrier network. The barrier network uses the barrier communication system to implement software barriers for synchronization of similar processes on the compute nodes to move to a different phase of processing upon completion of some task. There is also a global interrupt connection to each of the nodes.

Additional information about the Blue Gene/L system, its architecture, and its software can be found in the IBM Journal of Research and Development, vol. 49, No. 2/3 (2005), which is herein incorporated by reference in its entirety.

FIG. 2 illustrates a block diagram of a compute node 110 in the Blue Gene/L computer system according to the prior art. The compute node 110 has a node compute chip 112 that has two processing units 210A, 210B. Each processing unit 210, has a processing core 212 with a level one memory cache (L1 cache) 214. The processing units 210 also each have a level two memory cache (L2 cache) 216. The processing units 210 are connected to a level three memory cache (L3 cache) 220, and to an SRAM memory bank 230. The SRAM memory bank 230 could be any block of static memory. Data from the L3 cache 220 is loaded to a bank of DDR SDRAM 240 (memory) by means of a DDR controller 250. The DDR controller 250 has a number of hardware controller parameter registers 255. During the boot process, a boot loader 235 is loaded to SRAM 230. The boot loader 235 then programs the DDR controller 250 as described further below.

Again referring to FIG. 2, the SRAM memory 230 is connected to a JTAG interface 260 that communicates off the compute chip 112 to the Ido chip 180. The service node communicates with the compute node through the Ido chip 180 over an ethernet link that is part of the control system network 150 (described above with reference to FIG. 1). In the Blue Gene/L system there is one Ido chip per node board 120 and additional Ido chips are located on the link cards (not shown) and a service card (not shown) on the midplane 132 (FIG. 1). The Ido chips receive commands from the service node using raw UDP packets over a trusted private 100 Mbit/s Ethernet control network. The Ido chips support a variety of serial protocols for communication with the compute nodes. The JTAG protocol is used for reading and writing from the service node 140 (FIG. 1) to any address of the SRAMs 230 in the compute nodes 110 and is used for the system initialization and booting process.

The boot process for a node consists of the following steps: first, a small boot loader is directly written into the compute node static memory 230 by the service node using the JTAG control network. The boot loader then loads a much larger boot image into the memory of the node through a custom JTAG mailbox protocol. One boot image is used for all the compute nodes and another boot image is used for all the I/O nodes. The boot image for the compute nodes contains the code for the compute node kernel, and is approximately 128 kB in size. The boot image for the I/O nodes contains the code for the Linux operating system (approximately 2 MB in size) and the image of a ramdisk that contains the root file system for the I/O node. After an I/O node boots, it can mount additional file systems from external file servers. Since the same boot image is used for each node, additional node specific configuration information (such as torus coordinates, tree addresses, MAC or IP addresses) must be loaded separately. This node specific information is stored in the personality for the node. In preferred embodiments, the personality includes data for configuring the DDR controllers derived from an XML file as described herein. In contrast, in the prior art, the parameters setting for the controller parameter registers 255 were hardcoded into the boot loader. And thus, in the prior art, changing the parameters settings would require recoding and compilation of the boot loader code.

FIG. 3 shows a block diagram that represents the flow of DDR controller settings or parameters through the computer system during the boot process according to preferred embodiments herein. An XML file 162 is created and stored in the bulk storage 160 of the system as described in FIG. 1. When the system boot is started, the XML file 162 is read from the bulk storage 140 and the personality configurator 142 in the service node 140 uses the description of the DDR settings in the XML file 162 to load the node personality 144 with the appropriate DDR register data 146. The service node then loads the personality into the SRAM 230 as described above. When the boot loader executes on the node, it configures the DDR controller 250 by loading the register data 146 into the controller parameter registers 220 from the SRAM 230.

The DDR controller parameters include a variety of setting for the operation of the DDR controller. These settings include DDR memory timings parameters for memory chips from different manufacturers (e.g., CAS2CAS delays . . . and other memory settings), defective part workarounds such as steering data around a bad DDR chip and enabling special features of the DDR controller such as special modes for diagnostics. The parameters further may include memory interface tuning such as to optimize the DDR controller to favor writes vs. read operations, which might benefit certain types of users or applications. In addition, other parameters that may be used in current or future memory controllers are expressly included in the scope of the preferred embodiments.

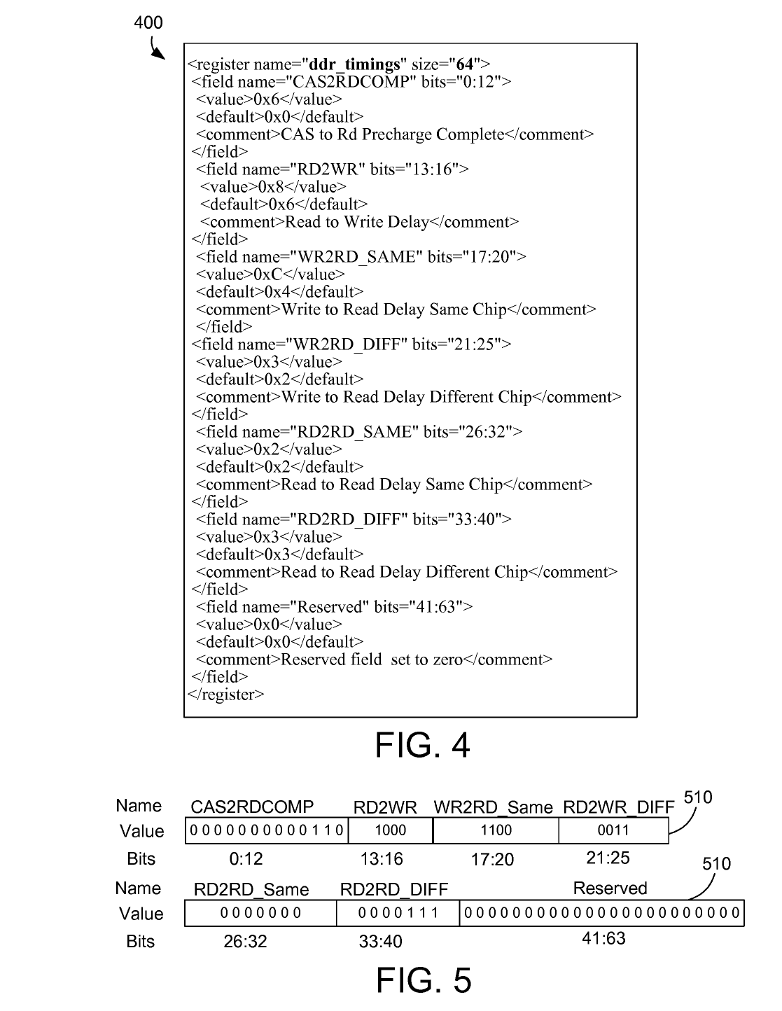

FIG. 4 illustrates an example of an XML file 162 according to the preferred embodiments. FIG. 4 represents a partial XML file and contains the information to create the register data and configure only a single register of the DDR controller, which may have many different registers in addition to the one illustrated. In this example, the XML file contains information to create register data for the controller parameter register named “ddr_timings” as indicated by the first line of the XML file. The first line also indicates that the size of the controller parameter register is 64 bits. The XML file then has seven fields that have information for seven parameters in this register. Each register field has a “name”, a number of “bits”, a “value”, a “default value” and a “comment”. The “name” of the field corresponds to the name of the controller parameter. The “value” represents the value in HEX that will be changed to a binary value and used to set the DDR controller parameter register. The “default value” is the default value for this parameter as dictated by the hardware. The “comment” is used to describe the field in more detail. In FIG. 4, each of the fields represent common timing parameters for DRAM memory, and are representative of the type of controller parameters that can be set using the apparatus and method described herein.

FIG. 5 illustrates the binary register data 510 that results from the configurator processing the XML file shown in FIG. 4 according to preferred embodiments herein. The configurator is preferably a software program running on the service node 140 (FIG. 1) that processes the XML previously prepared and stored in bulk storage 160 (FIG. 1). FIG. 5 also includes the name and number of bits for each field for reference to the reader and for comparison to FIG. 4. The register data 510 created by the configurator just includes the binary data shown 510. The binary register data 510 will be loaded into the SRAM and then used to configure the DDR controller by the boot loader as described herein.

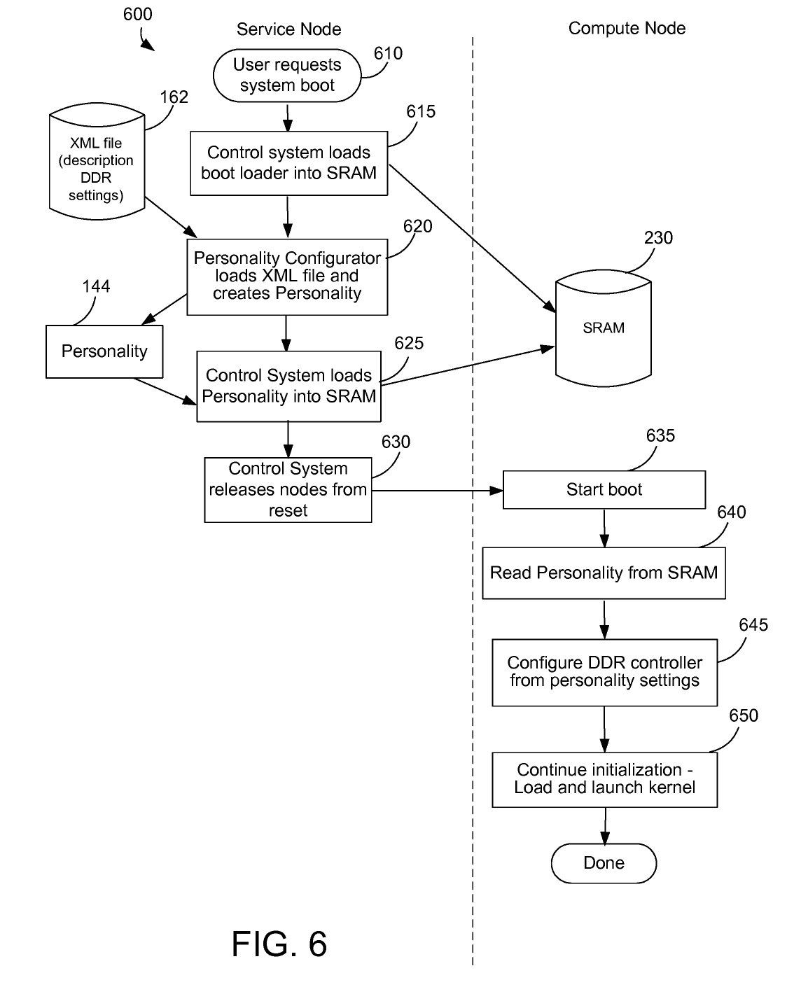

FIG. 6 shows a method 600 for configuration of a memory controller using an XML input file in a parallel computer system according to embodiments herein. The steps shown on the left hand side of FIG. 6 are steps that are performed within the service node 140, and the steps on the right hand side of FIG. 6 are performed within the compute nodes 110 (FIG. 1). The method begins in response to a user request to boot the system (step 610). In response to the request to boot the system, the service node control system loads a boot loader into SRAM on the compute node 615. The control system then executes the personality configurator 142 that loads the XML file 162 to create a personality 144 for each compute node in the system (step 620). The control system then loads the personality into the SRAM 230 (step 625). The control system then releases the compute nodes from reset to start the boot process (step 630).

The method 600 next looks to the steps that are performed in the compute nodes. The nodes start boot when released from reset by the control system (step 635). The personality for the node is read from the SRAM (step 640). The DDR controller is configured using the personality settings (step 645). The initialization of the compute node is then continued by launching the kernel as is known in the prior art (step 650). The method 600 is then complete.

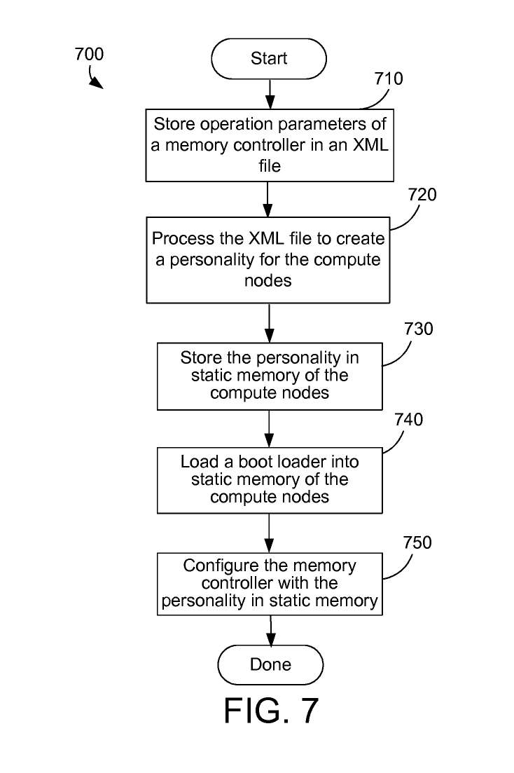

FIG. 7 shows another method 700 for configuration of a memory controller using an XML input file in a parallel computer system according to embodiments herein. The method begins by storing the operation parameters of a memory controller in an XML file (step 710). The XML file is processed to create a personality for the compute nodes (step 720). The personality is then stored in static memory of one or more compute nodes (step 730). When the boot process is initiated, a boot loader is loaded into static memory of the compute nodes (step 740). The memory controller is then configured with the personality stored in static memory (step 750). The method is then done.

As described above, embodiments provide a method and apparatus for configuration of a memory controller in a parallel super computer system. Embodiments herein allow the memory controller settings to be reconfigured easily without recompiling the boot loader to reduce costs and increase efficiency of the computer system.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. A parallel computer system comprising:
a plurality of compute nodes, each compute node comprising:
a) a processing unit;
b) memory;
c) a memory controller;
a bulk storage device with an extensible markup language (XML) file describing operation parameters for the memory controller; and
a service node for controlling the operation of the compute nodes over a network that includes a personality configurator that uses the XML file to build a unique personality for the compute nodes that includes operation parameters for the memory controller.

2. The parallel computer system of claim 1 wherein the network is connected to an interface on the compute node to allow the service node to load the personality into an static memory for configuration of the memory controller.

3. The parallel computer system of claim 1 wherein the operation parameters stored in the XML file include parameters selected from the following: memory timings, defective part workarounds, enabling special features of the memory controller, and memory interface tuning.

4. The parallel computer system of claim 1 wherein the memory type is selected from one of the following: dynamic random access memory (DRAM), synchronous DRAM (SDRAM), and double data rate SDRAM (DDR SDRAM).

5. The parallel computer system of claim 1 wherein the configurator creates a personality that contains binary register data that is stored in static memory.

6. The parallel computer system of claim 5 wherein the binary register data is stored in a controller parameter register in the memory controller.

7. The parallel computer system of claim 1 wherein the memory controller is a DDR SDRAM memory controller.

8. A parallel computer system comprising:
a plurality of compute nodes, each compute node comprising:
a) a processing unit;
b) DRAM memory;
c) a DRAM memory controller;
a bulk storage device with an extensible markup language (XML) file describing operation parameters for the memory controller; and
a service node for controlling the operation of the compute nodes over a network, the service node including a personality configurator that uses the XML file to build a unique personality that contains binary register data containing operation parameters for storing in a controller parameter register in the DRAM memory controller.

9. The parallel computer system of claim 8 wherein the network is connected to an interface on the compute node to allow the service node to load the personality into an static memory for configuration of the DRAM memory controller.

10. The parallel computer system of claim 8 wherein the operation parameters stored in the XML file include parameters selected from the following: DDR memory timings, defective part workarounds, enabling special features of the DDR controller, and memory interface tuning.

11. The parallel computer system of claim 8 wherein the memory type is selected from one of the following: DRAM, SDRAM, and DDR SDRAM.

12. The parallel computer system of claim 8 wherein the memory controller is a DDR SDRAM memory controller.

13. A computer-implemented method for operating a parallel computer system comprising the steps of:
a) storing operation parameters of a memory controller in an extensible markup language (XML) file;
b) processing the XMLfile to create a personality with binary register data;
c) storing the personality in static memory of a compute node;
d) loading a boot loader into the compute nodes; and
e) the boot loader configuring the memory controller with the personality stored in the static memory.

14. The computer-implemented method of claim 13 wherein the memory controller is a DDR DRAM controller.

15. The computer-implemented method of claim 13 wherein the operation parameters stored in the XML file include parameters selected from the following: DDR memory timings, defective part workarounds, enabling special features of the DDR controller, and memory interface tuning.

16. The computer-implemented method of claim 13 wherein the memory type is selected from one of the following: DRAM, SDRAM, and DDR SDRAM.

17. The computer-implemented method of claim 13 wherein the binary register data is stored in a controller parameter register in the memory controller.

18. The computer-implemented method of claim 13 wherein the memory controller is a DDR SDRAM memory controller.
